(19) United States
(12) Patent Application Publication
(10) Pub. No.: US 2009/0149218 A1
(43) Pub. Date: Jun. 11, 2009

(54) Mobile telephone relationships

(75) Inventors: Liang Chen, Beijing (CN); Wei Hun Liew, Beijing (CN); Rebecca J. Sundling, Beijing (CN); Difei Tang, Beijing (CN); Sun H. Shaw, Beijing (CN); Guobin Shen, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/953,871

(22) Filed: Dec. 11, 2007

(51) Int. Cl. H04M 1/00; G06F 15/16

(52) U.S. Cl. 455/557; 709/248

(57) ABSTRACT

Described is a technology by which mobile telephones are organized and/or operate based upon special relationships with other users and/or other mobile telephones. A mobile computing device is coupled to another mobile computing device so as to have a special relationship therewith, including after subsequent decoupling. When the mobile telephones that have a special relationship are thereafter coupled together, the devices may operate differently (relative to their operation when coupled to other mobile telephones). Also described is a single user interface screen that outputs an identifier (e.g., an image) of a potential recipient, along with communication options, such as to call, send a text message, share data, show information or send a predefined message.

### BACKGROUND

Mobile telephones are no longer simply communication devices. For example, in addition to placing and receiving telephone calls, mobile telephones can provide some computing functionality, obtain and output media files (e.g., photographs, music, or video), and perform other operations such as providing email and internet access.

Mobile telephones are thus becoming more like hybrids of communication, computing and other electronic devices. However, mobile telephones with such computing functionality are generally designed like business-centric computers, with the central focus of the interface design and like features being to provide access to computer programs. This is true even though many mobile telephone users primarily use their telephones for personal communication based on personal relationships.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which mobile telephones are organized and/or operate based upon special relationships with other users and/or other mobile telephones. In one aspect, two or more mobile computing devices may be configured to have a special relationship, such that when thereafter coupled together, operate differently relative to other (non-related) mobile telephones. A special coupling means may create the special relationship. For example, when in the specially-coupled mode, the devices may automatically transfer data to one another, automatically changes a display or audible output, and change a response when it detects a communication from a related device.

In one aspect, a single user interface screen outputs an identifier (e.g., an image) of a potential recipient in association with a set of communication options with respect to that recipient. For specially coupled telephones, an identifier for each other user or users may be automatically included in such a user interface. Upon selection of a communication option, the device automatically selects that recipient and takes a communication-related action to with respect to the selected recipient. For example, the communication options may include an option for sending a text message, for placing a call, for sending a special type of predefined message and/or an option to share data. Another option that may be provided is an option to view information related to communications with that recipient (e.g., prior calls, missed calls, prior messages and so forth).

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIGS. 1A and 1B are a block diagrams representing example components of a mobile telephone configured to operate in a relationship-based mode.

FIG. 2 is a representation of an example person-centric user interface that provides for easy communication and other access based on a personal relationship.

FIG. 3 is a representation of an example user interface with an automatically generated “To:” selection when selecting SMS (simple message service) from the person-centric user interface of FIG. 2.

FIG. 4 is a representation of another example person-centric user interface.

FIG. 5 is a representation of an example user interface that automatically provides communication-related information for a specific person when an “Info” button is chosen via the person-centric user interface of FIG. 4 when that specific person has focus.

FIG. 6 is a representation of example components of a mobile telephone that is configurable to have a special relationship with another mobile telephone.

FIGS. 7-9 show examples of closely related telephones may operate in a different manner when coupled to one another.

FIG. 10 shows an illustrative example of a computing and communication device into which various aspects of the present invention may be incorporated.

### DETAILED DESCRIPTION

Various aspects of the technology described herein are generally directed towards mobile telephones that are organized and operate based upon special relationships with other users and/or other mobile telephones. In general, examples of relationship-based organization and operation include a person-centric user interface for communicating with one or more persons identified as having a relationship, special messaging between related telephone users, and a special coupling relationship for two or more particular telephones.

As will be understood, various examples set forth herein are primarily described with respect to a relationship between two or three mobile telephones, however it is understood that any practical number of mobile telephones or like communication-capable devices may operate, share information and/or output information in the manner described herein. Further, while the concept of a related “person” or individual persons is generally described herein, it can be readily appreciated that it is feasible to have special relationships with a “group” of more than one person. For example, a mother may send a text message to a group comprising her children; the mobile telephone may then send out a series of such messages to each member in the group, for example.

As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in mobile devices and communication in general.

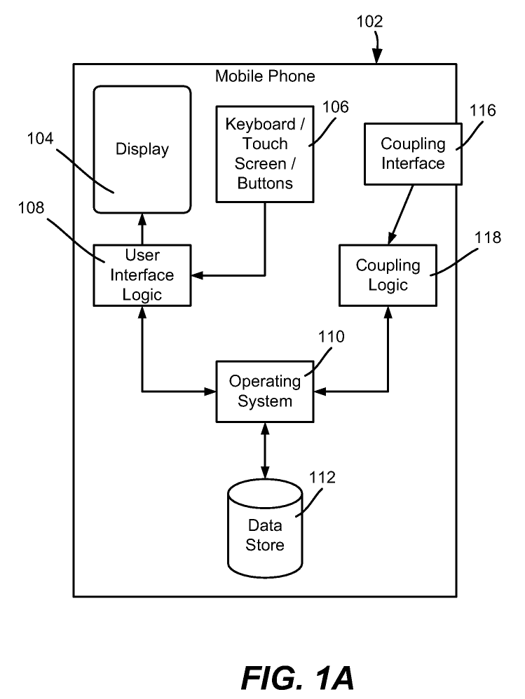

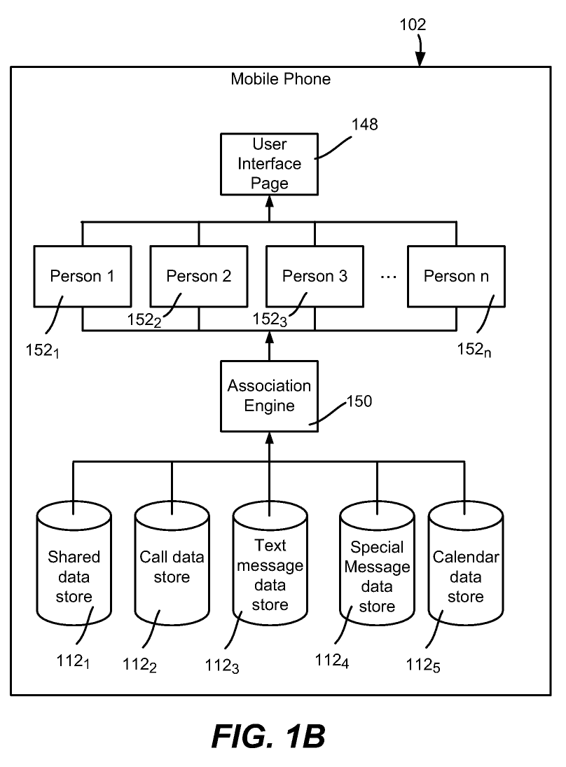

Turning to FIG. 1A, there is shown a mobile telephone 102 that is capable of being operated in a person-centric mode, which in general is more directed towards communication with at least one other person, as opposed to application-centric operations. The person-centric mode may be the only mode on such a mobile telephone, but alternatively may be one mode of a multiple-mode telephone, e.g., a device that toggles between a person-centric mode and a conventional application-centric mode. The person-centric mode may operate by default, and/or may be switched to by manual interaction or automatic trigger (e.g., time-of-day, a sensed location such as home instead of work, a call from another, and so forth).

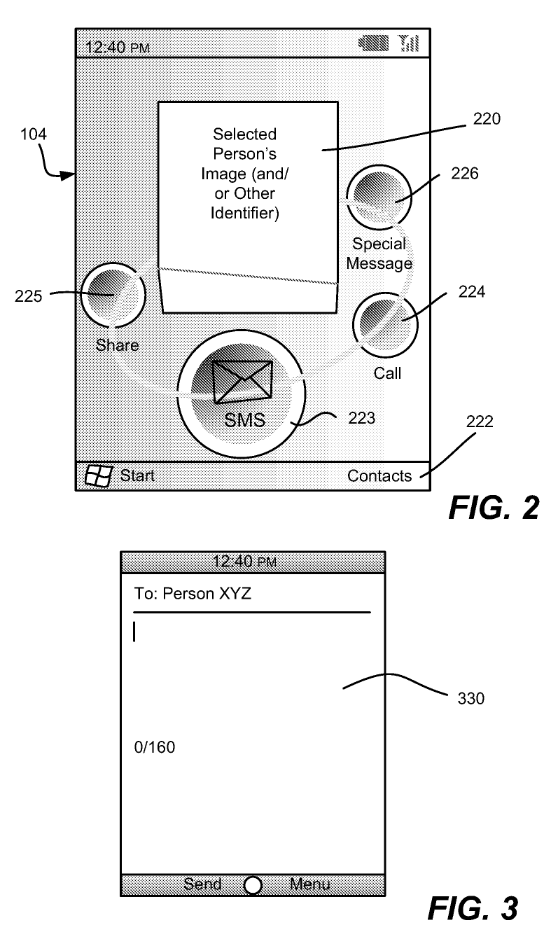

By way of example, FIG. 2 shows how one user interface screen display 104 may appear when a person-centric mode is active with respect to a specific person (or specific group, as described above). An image 220 (or other identifier such as a text name, logo or the like) of that person appears. If there is more than one specific person to which the person-centric mode may apply, any one of various selection mechanisms may be used to switch among such persons. For example, a contacts interface such as invoked by an icon 222 may be used to select a particular person, but other means such as a scroll wheel, D-pad, touch-sensitive icon or button and so forth may be used for selection of another as the currently selected person to whom operation is focused.

In the example of FIG. 2, a number of person-centric action icons surround the image, with which a user can interact to communicate with the currently selected person. Example actions corresponding to icons/buttons 223-226 respectively include sending a text (SMS) message to the selected person, calling the person, sharing content (e.g., media such as photos, audio or video, calendar data, tasks and so forth) with the person, and/or transmitting a predefined message (e.g., voice or text) of a stored set. Other example actions may include sending email, game playing and essentially anything two or more users (or groups) can share in.

As can be seen, the user may initiate an action with respect to the currently displayed person. For example, an action in the form of a text message operation may be performed simply by selecting a recipient (if one is not already selected) and interacting with the SMS icon 223, or with the icon in focus (as indicated by its larger size). If the user chooses SMS, for example, a displayed screen 330 such as that shown in FIG. 3 may appear for the user to enter text, e.g., via a physical or virtual keyboard, or other means (e.g., speech, handwriting or gesture recognition). Note that the intended receiver of the text message (person XYZ) is automatically identified; there is no need to enter a telephone number to send the text message.

Returning to FIG. 1A, the user interacts with the device based on the output of the current display 104 via a keyboard, touch screen and/or other buttons 106. User interface logic 108 which may be part of the operating system 110 or associated with the operating system 110 provide a way to couple user input interaction with the display output and other actions, based on person-centric and other data in a data store 112 maintained on the device. For example, each person (or group) that corresponds to a contact may have a set of records maintained for them. Alternatively, only certain contacts may be flagged for person-centric operations, that is, those with whom the user has indicated as having a special relationship.

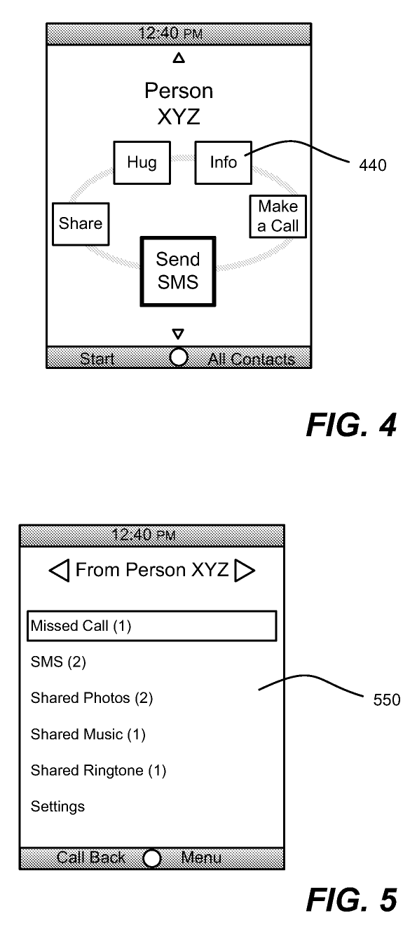

A user can also access information related to a specific person from the device screen. FIG. 4 shows how a selected person's information may be accessed, via an “Info” button 440 or the like. FIG. 5 shows an example of what may appear regarding a selected person (person XYZ) upon selecting the “Info” button 440 of FIG. 4, namely data related to communications and/or data sharing with the selected person.

FIG. 1B shows an example of how various example types of data 112₁-112₅ may be arranged for access in the data store 112. As a user selects a person (e.g., a person identity 152₁ from a set of persons 152₁-152ₙ) for the person-centric user interface (the displayed page) 148, an association engine 150 or the like may access and associate the various data for that selected person, e.g., as needed according to user interaction with the page 148.

In this manner, rather than provide an application-centric home screen for mobile telephone users directed towards dealing with email, applications, and other enterprise-related tasks, a person-centric home screen and/or operating mode is provided by which users can easily send text messages and make phone calls to one or more important persons in their lives, as well as access information specific to those persons. These aspects thus match a real world user communication model, in which users often think about communicating with a person rather than running an application.

Turning to another aspect of mobile telephone relationships, two (or more) mobile telephones may be configured to have a special relationship with one another. The special relationship may be user defined, or may be defined in advance, e.g., as a pair of telephones purchased together and programmed by the manufacturer or service provider to have such a relationship.

In general, two or more mobile telephones with such a defined relationship enhance the ease of communication between related mobile phone users, and facilitate special communication between the two people. For example, specially paired telephones may leverage the person-centric aspects described above with reference to FIGS. 2-5.

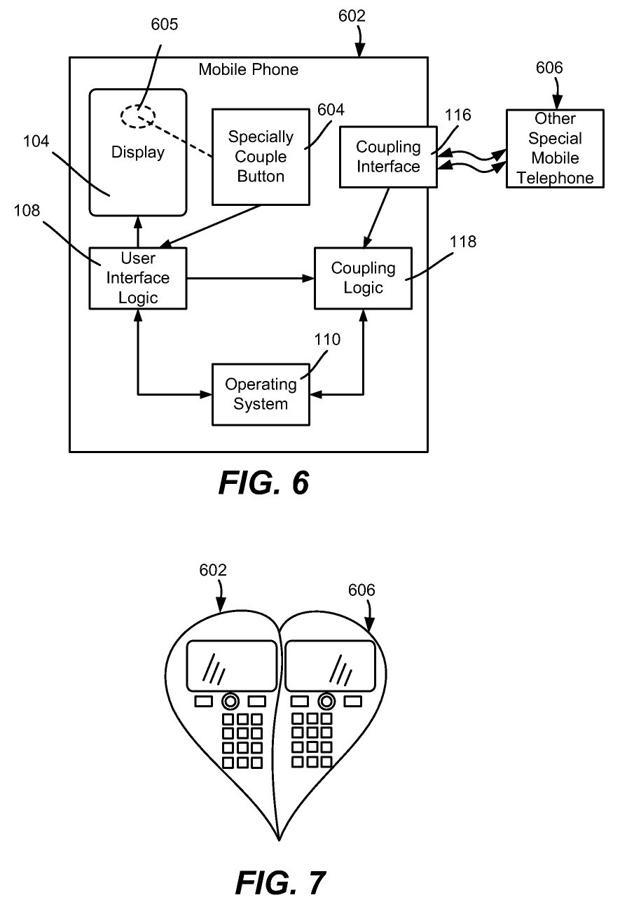

As generally represented in FIG. 6, a mobile telephone 602 may include a button 604 which when actuated, specially couples the mobile telephone 602 to another special mobile telephone 606 via a coupling interface 116 (FIG. 1A). The button may be a physical button, and/or an icon 605 displayed on a special coupling page, for example.

The other mobile telephone 606 may have an identical set of components, but does not need to be identical, e.g., one telephone can act as a master with respect to coupling. However, both telephones need to have coupling logic 118 that recognizes when they are each coupled, and a suitable coupling interface 116. Any interface is feasible, such as physical (wired) or wireless (e.g., Bluetooth® or Wi-Fi, or even cellular).

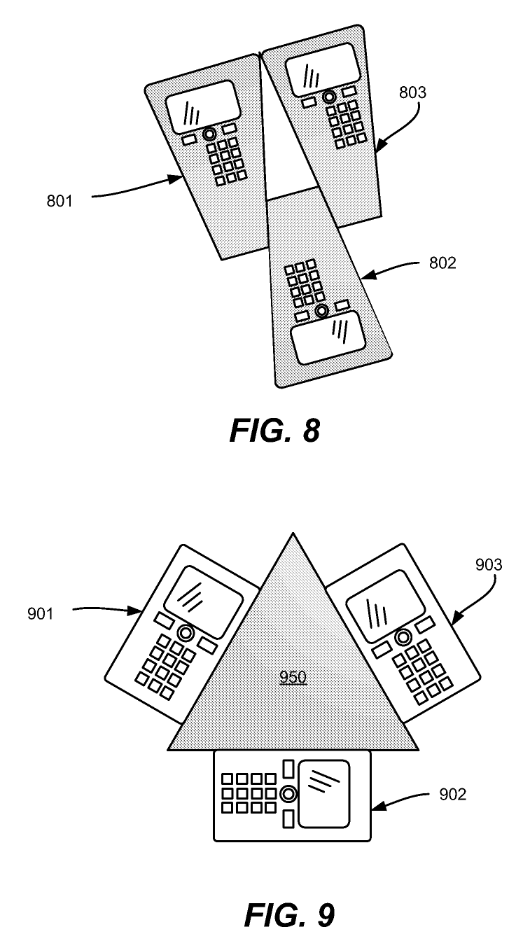

Such mobile telephones may thus operate differently when coupled together, whether physically coupled as in FIGS. 7-9, or via wireless communication. FIG. 7 shows the direct physical coupling of two phones (e.g., 602 and 606) primarily designed for lovers, FIG. 8 the direct physical coupling of up to three phones 801-803, and FIG. 9 an indirect coupling of up to three phones 901-903 (through some wired or wireless media 950). Any practical number of such phones may be coupled, e.g., a mother, father and three children may have special phone coupling relationships.

Examples of different operations when coupled or after the special relationship has been set up include sharing lifestyle information with another, sharing photos and songs directly, playing games together, sharing calendar/contact/task list data, easy location of the other (e.g., via GPS coordinates), one click dialing/messaging/sharing. A special button (e.g., an icon) may provide a way for one to easily access the other coupled telephone or phones.

Other examples include automatically detecting a related phone when the two phones are close to each other, and enabling special features such as a personalized ring tone, custom home screen or background, an SMS signature, and an automatic response for playing a personalized message only to the related telephone.

### Exemplary Operating Environment

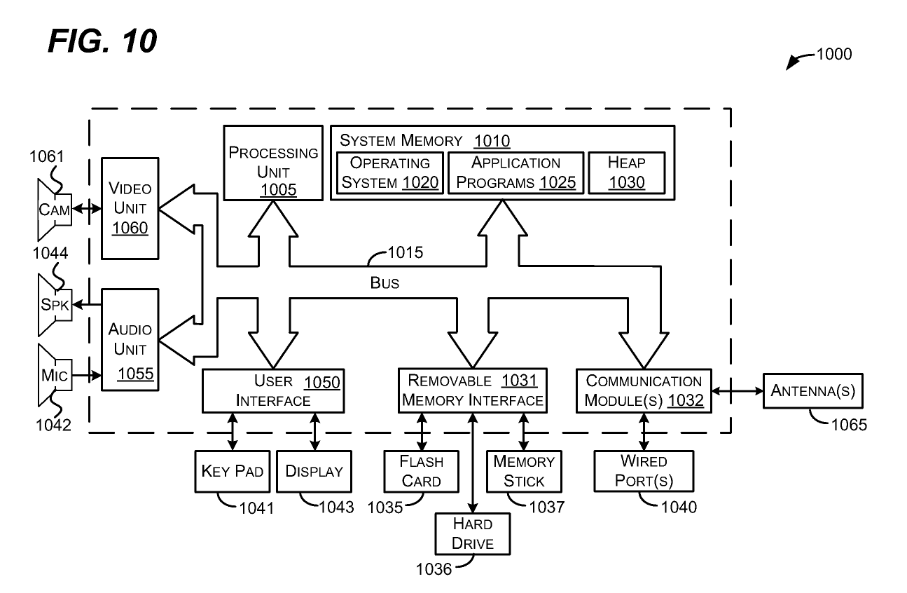

FIG. 10 illustrates an example of a suitable mobile device 1000 on which aspects of the subject matter described herein may be implemented. The mobile device 1000 is only one example of a device and is not intended to suggest any limitation as to the scope of use or functionality of aspects of the subject matter described herein. Neither should the mobile device 1000 be interpreted as having any dependency or requirement relating to any one or combination of components illustrated in the exemplary mobile device 1000.

With reference to FIG. 10, an exemplary device for implementing aspects of the subject matter described herein includes a mobile device 1000. In some embodiments, the mobile device 1000 comprises a cell phone, a handheld device that allows voice communications with others, some other voice communications device, or the like. In these embodiments, the mobile device 1000 may be equipped with a camera for taking pictures, although this may not be required in other embodiments. In other embodiments, the mobile device 1000 comprises a personal digital assistant (PDA), hand-held gaming device, notebook computer, printer, appliance including a set-top, media center, or other appliance, other mobile devices, or the like. In yet other embodiments, the mobile device 1000 may comprise devices that are generally considered non-mobile such as personal computers, servers, or the like.

Components of the mobile device 1000 may include, but are not limited to, a processing unit 1005, system memory 1010, and a bus 1015 that couples various system components including the system memory 1010 to the processing unit 1005. The bus 1015 may include any of several types of bus structures including a memory bus, memory controller, a peripheral bus, and a local bus using any of a variety of bus architectures, and the like. The bus 1015 allows data to be transmitted between various components of the mobile device 1000.

The mobile device 1000 may include a variety of computer-readable media. Computer-readable media can be any available media that can be accessed by the mobile device 1000 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 1000.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, Wi-Fi, WiMAX, and other wireless media. Combinations of any of the above should also be included within the scope of computer-readable media.

The system memory 1010 includes computer storage media in the form of volatile and/or nonvolatile memory and may include read only memory (ROM) and random access memory (RAM). On a mobile device such as a cell phone, operating system code 1020 is sometimes included in ROM although, in other embodiments, this is not required. Similarly, application programs 1025 are often placed in RAM although again, in other embodiments, application programs may be placed in ROM or in other computer-readable memory. The heap 1030 provides memory for state associated with the operating system 1020 and the application programs 1025. For example, the operating system 1020 and application programs 1025 may store variables and data structures in the heap 1030 during their operations.

The mobile device 1000 may also include other removable/non-removable, volatile/nonvolatile memory. By way of example, FIG. 10 illustrates a flash card 1035, a hard disk drive 1036, and a memory stick 1037. The hard disk drive 1036 may be miniaturized to fit in a memory slot, for example. The mobile device 1000 may interface with these types of non-volatile removable memory via a removable memory interface 1031, or may be connected via a universal serial bus (USB), IEEE 10394, one or more of the wired port(s) 1040, or antenna(s) 1065. One of the antennas 1065 may receive GPS data. In these embodiments, the removable memory devices 1035-1037 may interface with the mobile device via the communications module(s) 1032. In some embodiments, not all of these types of memory may be included on a single mobile device. In other embodiments, one or more of these and other types of removable memory may be included on a single mobile device.

In some embodiments, the hard disk drive 1036 may be connected in such a way as to be more permanently attached to the mobile device 1000. For example, the hard disk drive 1036 may be connected to an interface such as parallel advanced technology attachment (PATA), serial advanced technology attachment (SATA) or otherwise, which may be connected to the bus 1015. In such embodiments, removing the hard drive may involve removing a cover of the mobile device 1000 and removing screws or other fasteners that connect the hard drive 1036 to support structures within the mobile device 1000.

The removable memory devices 1035-1037 and their associated computer storage media, discussed above and illustrated in FIG. 10, provide storage of computer-readable instructions, program modules, data structures, and other data for the mobile device 1000. For example, the removable memory device or devices 1035-1037 may store images taken by the mobile device 1000, voice recordings, contact information, programs, data for the programs and so forth.

A user may enter commands and information into the mobile device 1000 through input devices such as a key pad 1041 and the microphone 1042. In some embodiments, the display 1043 may be touch-sensitive screen and may allow a user to enter commands and information thereon. The key pad 1041 and display 1043 may be connected to the processing unit 1005 through a user input interface 1050 that is coupled to the bus 1015, but may also be connected by other interface and bus structures, such as the communications module(s) 1032 and wired port(s) 1040.

A user may communicate with other users via speaking into the microphone 1042 and via text messages that are entered on the key pad 1041 or a touch sensitive display 1043, for example. The audio unit 1055 may provide electrical signals to drive the speaker 1044 as well as receive and digitize audio signals received from the microphone 1042.

The mobile device 1000 may include a video unit 1060 that provides signals to drive a camera 1061. The video unit 1060 may also receive images obtained by the camera 1061 and provide these images to the processing unit 1005 and/or memory included on the mobile device 1000. The images obtained by the camera 1061 may comprise video, one or more images that do not form a video, or some combination thereof.

The communication module(s) 1032 may provide signals to and receive signals from one or more antenna(s) 1065. One of the antenna(s) 1065 may transmit and receive messages for a cell phone network. Another antenna may transmit and receive Bluetooth® messages. Yet another antenna (or a shared antenna) may transmit and receive network messages via a wireless Ethernet network standard.

In some embodiments, a single antenna may be used to transmit and/or receive messages for more than one type of network. For example, a single antenna may transmit and receive voice and packet messages.

When operated in a networked environment, the mobile device 1000 may connect to one or more remote devices. The remote devices may include a personal computer, a server, a router, a network PC, a cell phone, a peer device or other common network node, and typically includes many or all of the elements described above relative to the mobile device 1000.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server is often used herein, it will be recognized that this term may also encompass a client, a set of one or more processes distributed on one or more computers, one or more stand-alone storage devices, a set of one or more other devices, a combination of one or more of the above, and the like.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a mobile communications environment, a system comprising, a first mobile computing device and a second mobile computing device, each mobile computing device having coupling logic and a coupling interface, and special coupling means that when actuated, at a time that the first mobile computing device is coupled to the second mobile computing device via the coupling interface of each device, creates a special relationship between the first mobile computing device and the second mobile computing device, including an ability to operate in a specially-coupled mode whenever coupled together by any communication means thereafter.

2. The system of claim 1 wherein the special coupling means is programmed into the coupling logic of the first computing device.

3. The system of claim 1 wherein the special coupling means includes a specially-couple button on the first computing device.

4. The system of claim 3 wherein the specially-couple button on the first computing device comprises a physical button, or an icon on a visible display that can be actuated by touch-sensing or by being in focus in conjunction with a selection button.

5. The system of claim 1 wherein the coupling logic on at least one of the devices automatically transfers data when in the specially-coupled mode.

6. The system of claim 1 wherein the coupling logic on at least one of the devices automatically changes a display when in the specially-coupled mode.

7. The system of claim 1 wherein the coupling logic on the first mobile communications device changes its response when it detects a communication from the second mobile communications device.

8. The system of claim 1 wherein the coupling interface on each mobile communications device is configured to physically couple to each other at the time when the special coupling means is actuated.

9. The system of claim 1 wherein the coupling interface on each mobile communications device is configured to physically couple to an intermediate medium at the time when the special coupling means is actuated.

10. The system of claim 1 wherein the coupling interface on each mobile communications device is configured to wirelessly couple through a non-cellular connection at a time when the special coupling means is actuated.

11. The system of claim 10 wherein the non-cellular connection comprises a Bluetooth® or Wi-Fi connection.

12. The system of claim 1 further comprising a user interface page on the first mobile computing device, the user interface page including an identifier of a potential recipient in association with a set of communication options with respect to that recipient, and wherein the special relationship created between the first mobile computing device and the second mobile computing device provides data including an identifier corresponding to a user of the second mobile computing device for use as one potential recipient displayable on the user interface page.

13. In a mobile communications environment, a method comprising, coupling a set of at least two mobile telephones together to each have an ability to operate in a specially-coupled mode whenever one mobile telephone is thereafter coupled together with at least one other mobile telephone of the set, decoupling the set of mobile telephones, and re-coupling the set of mobile telephones, and operating at least two of the mobile telephones in the specially-coupled mode when re-coupled.

14. The method of claim 13 wherein coupling the set comprises coupling over a first communication medium, and wherein re-coupling the set comprises coupling over a second communication medium that is different from the first communication medium.

15. The method of claim 13 wherein coupling the set to operate in the specially-coupled mode further comprises receiving a request to specially couple the mobile telephones.

16. In a mobile communications environment, a method comprising, coupling a first mobile telephone to a second mobile telephone to operate in a specially-coupled mode whenever the first and second mobile telephones are thereafter coupled together, transferring data from the second mobile telephone to the first mobile telephone, including data corresponding to an identifier of the second mobile telephone and communication data by which the first mobile telephone may communicate with the second mobile telephone, decoupling the first mobile telephone from the second mobile telephone, presenting the identifier of the second mobile telephone on a user interface page of the first mobile telephone, the identifier presented in association with communication options related to the second mobile telephone, detecting selection of a communication option, and using the communication data to communicate with the second mobile telephone based on the selection of the communication option.

17. The method of claim 16 wherein the communication options include an option for sending a text message and an option for placing a call, and when detecting selection comprises detecting a request to send a text message, using the communication data comprises automatically selecting a transmission destination associated with the second mobile telephone, and when detecting selection comprises detecting a request to place a call, using the communication data comprises automatically dialing a telephone number associated with the second mobile telephone.

18. The method of claim 16 wherein the communication options include an option for sending a predefined message, wherein detecting selection comprises detecting a request to send a predefined message, and wherein using the communication data comprises sending the predefined message to a transmission destination associated with the second mobile telephone.

19. The method of claim 16 wherein the communication options include an option for sharing content, wherein detecting selection comprises detecting a request to share content, and wherein using the communication data comprises communicating with the second mobile telephone to share content.

20. The method of claim 16 further comprising, presenting the identifier in association with an information option related to the second mobile telephone, detecting selection of the information option, and in response to the selection, operating the first mobile telephone to retrieve communication-related information corresponding to the second mobile telephone.
